(19) United States
(12) Patent Application Publication
(10) Pub. No.: US 2025/0294385 A1
(43) Pub. Date: Sep. 18, 2025

(54) 5G SLICE PERFORMANCE INDICATOR

(71) Applicant: T-MOBILE INNOVATIONS LLC, Overland Park, KS (US)

(72) Inventor: Muhammad Tawhidur RAHMAN, Sammamish, WA (US)

(21) Appl. No.: 18/605,740

(22) Filed: Mar. 14, 2024

(51) Int. Cl. H04W 24/08; H04W 24/02; H04W 48/16

(52) U.S. Cl. CPC H04W 24/08; H04W 24/02; H04W 48/16

(57) ABSTRACT

Systems and methods are provided for deriving insights of customer key performance indicators (KPI's) (e.g., throughput, latency, connection reliability, etc.) in 5G slicing. By using signaling transaction logs from 5G SA Core Platforms, such as the PCF and UPF, full visibility can be provided to ensure customer satisfaction. The data on these KPIs can allow the mobile operator to derive the subscriber's experience metrics based on their specific location to make real-time dynamic changes based on this visibility data.

### SUMMARY

A high-level overview of various aspects of the present technology is provided in this section to introduce a selection of concepts that are further described below in the detailed description section of this disclosure. This summary is not intended to identify key or essential features of the claimed subject matter, nor is it intended to be used as an aid in isolation to determine the scope of the claimed subject matter.

In aspects set forth herein, systems and methods are provided for deriving insights of customer key performance indicators (KPI's) (e.g., throughput, latency, connection reliability, etc.) in 5G slicing. 5G slicing allows for customized and differentiated services tailored to specific subscriber needs. A lack of performance measurement framework means operators may struggle to guarantee the promised service levels, potentially leading to customer dissatisfaction and a negative impact on user (i.e., subscriber) experience.

### BRIEF DESCRIPTION OF THE SEVERAL VIEWS OF THE DRAWINGS

Implementations of the present disclosure are described in detail below with reference to the attached drawing figures, wherein:

FIG. 1 depicts a diagram of an exemplary network environment in which implementations of the present disclosure may be employed, in accordance with aspects herein;

FIG. 2 depicts a flow diagram of a method for deriving 5G slicing insight at a telecommunications network, in accordance with aspects herein; and

FIG. 3 depicts a diagram of an exemplary computing environment suitable for use in implementations of the present disclosure, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:

| | |
|---|---|
| 3G | Third-Generation Wireless Technology |
| 4G | Fourth-Generation Cellular Communication |
| | System |
| 5G | Fifth-Generation Cellular Communication System |
| AMF | Access & Mobility Management Function |
| APN | Access Point Name |
| CD-ROM | Compact Disk Read Only Memory |
| CDMA | Code Division Multiple Access |
| eNodeB | Evolved Node B |
| GIS | Geographic/Geographical/Geospatial Information |
| | System |
| gNodeB | Next Generation Node B |
| GPRS | General Packet Radio Service |
| GSM | Global System for Mobile communications |
| iDEN | Integrated Digital Enhanced Network |
| DVD | Digital Versatile Discs |
| EEPROM | Electrically Erasable Programmable Read Only |
| | Memory |
| LED | Light Emitting Diode |
| LTE | Long Term Evolution |
| MIMO | Multiple Input Multiple Output |
| MD | Mobile Device |
| PC | Personal Computer |
| PCF | Policy Control Function |
| PCS | Personal Communications Service |
| PDA | Personal Digital Assistant |
| RAM | Random Access Memory |
| RET | Remote Electrical Tilt |
| RF | Radio-Frequency |
| RFI | Radio-Frequency Interference |
| R/N | Relay Node |
| ROM | Read Only Memory |
| SINR | Transmission-to-Interference-Plus-Noise Ratio |
| SMF | Session Management Function |
| SNR | Transmission-to-noise ratio |
| SON | Self-Organizing Networks |
| TDMA | Time Division Multiple Access |
| TXRU | Transceiver (or Transceiver Unit) |
| UDM | Unified Data Management Function |
| UDR | Unified Data Repository |
| UE | User Equipment |
| UPF | User Plane Function |

Further, various technical terms are used throughout this description. An illustrative resource that fleshes out various aspects of these terms can be found in Newton's Telecom Dictionary, 32d Edition (2022).

As used herein, the term “node” is used to refer to network access technology for the provision of wireless telecommunication services from a base station to one or more electronic devices, such as an eNodeB, gNodeB, etc.

Embodiments of the present technology may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media.

Computer-readable media include both volatile and nonvolatile media, removable and non-removable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

As employed herein, a UE (also referenced herein as a user device) can include any device employed by an end-user to communicate with a wireless telecommunications network. A UE can include a mobile device, a mobile broadband adapter, or any other communications device employed to communicate with the wireless telecommunications network. A UE, as one of ordinary skill in the art may appreciate, generally includes one or more antenna coupled to a radio for exchanging (e.g., transmitting and receiving) transmissions with a nearby base station.

By way of background, slicing is an emerging technology in 5G Standalone (SA) Networks, and it enables mobile operators to provide specialized treatment for specific traffic flows, applications, or subscribers. For example, slicing allows for creating virtual partitions in the network to cater to unique needs of different applications or subscriber needs, such as ensuring low latency for mobile gaming or stringent security measures for banking applications. However, there is currently no clear framework in place for assessing the performance of 5G slicing with the desired level of detail. This absence of a clear framework hinders operators from analyzing service levels of their customers, leaving the operators unaware of critical aspects, such as KPIs. The operators are unable to see what is going on in the traffic descriptors and unable to demand certain slices go to certain applications. This limitation is attributed to the new features introduced by 5G slicing, such as call flow and signaling, which are not currently captured in existing network logs. Despite its transformative potential, the effectiveness of 5G slicing is hindered by the current absence of a comprehensive performance measurement network.

Providing context, the evolution of 5G telecommunication networks introduces two main deployment architectures: Non-Standalone (NSA) and Standalone (SA) networks. These architectures represent different approaches to implementing the fifth-generation (5G) wireless technology, each serving specific needs and paving the way for the comprehensive realization of the 5G vision. In the early phases of 5G deployment, the NSA architecture was introduced as an intermediate step toward achieving full 5G capabilities. NSA relies on the existing 4G LTE (Long-Term Evolution) infrastructure, utilizing LTE's control plane for certain functions. This allows for a quicker rollout of 5G services while still benefiting from the enhanced data rates and low-latency promised by 5G. However, NSA does not fully exploit the unique features and capabilities that come with a dedicated 5G core network. Alternatively, the SA architecture represents the most advanced and complete implementation of 5G. Unlike NSA, 5G SA does not depend on LTE infrastructure, featuring a dedicated 5G core network. This enables the full realization of the transformative capabilities of 5G, including ultra-reliable low-latency communication, massive device connectivity, and network slicing.

As mentioned above, network slicing is a pivotal feature of 5G SA that allows the creation of isolated virtual networks, known as slices, tailored to specific applications or services. Within the SA architecture, signaling transaction logs play a crucial role in managing and monitoring these network slices. Key components include the Policy Control Function (PCF) and User Plane Function (UPF). The PCF is responsible for managing policies related to each network slice, determining parameters such as quality of service, access control, and resource allocation. It provides a clear understanding of which slice a communication transaction is associated with, ensuring that the network behaves according to the predefined policies for that slice. On the other hand, the UPF handles the actual data payload within a network slice. The UPF plays a pivotal role in executing the policies set by the PCF, managing the data flow, and ensuring that the transmitted information aligns with the characteristics and requirements of the specific slice.

In the realm of 5G network slicing, telecommunications operators can implement two distinct types of slicing, each catering to specific use cases and demands for customized network services. These slicing approaches offer a level of granularity and flexibility that was not achievable in previous generations of wireless technology. The first type of slicing operates on the principle of providing a consistent and uniform experience to users, irrespective of their specific activities on the network. In this scenario, users are allocated the same slice regardless of whether they are engaged in video streaming, online gaming, simple web browsing, or the like. This type of network slicing is particularly advantageous for telecommunications carriers as it simplifies management and does not necessitate specific treatment for different types of traffic. Historically, such uniformity sufficed for user needs, and isolating network resources for distinct applications was not a priority.

However, as the demands on mobile networks grow, especially with the arrival of advanced applications like augmented reality (AR) and virtual reality (VR), a more sophisticated approach to network slicing becomes crucial. The second type of slicing is specifically tailored for these advanced use cases. In this context, the telecommunications carrier dynamically allocates different slices based on the user's engagement with specific applications. For example, a unique slice might be dedicated to gaming, ensuring low latency and high bandwidth, while another slice may be optimized for streaming high-definition video content. This second type of slicing offers operators the opportunity to isolate and treat each application flow differently, responding to the diverse requirements of applications such as Facebook™, news, email, Netflix™, games, etc. By dynamically adjusting network resources based on the specific needs of each application, telecommunications carriers can enhance the overall quality of service and deliver a more tailored and optimized user experience. As 5G networks evolve, the capability to finely tune network slices for distinct applications becomes a powerful tool for meeting the diverse demands of the modern digital landscape.

In the current landscape of 5G network slicing, a notable challenge lies in the limited visibility into the intricacies of the network's operational dynamics. Intermediate nodes within the core network and the Radio Access Network (RAN) currently lack the capability to discern detailed information about traffic descriptors and route description parameters associated with specific slices. This absence of visibility presents a significant hurdle as telecommunications operators are unable to demand or enforce specific behaviors within the network.

The intricacies of application-specific network slices remain concealed from intermediate nodes, preventing a clear understanding of which slice is allocated to a particular application and when these slices are actively in use. The lack of visibility at intermediate points within the network results in an operational blind spot, making it challenging for network administrators to optimize resource allocation, troubleshoot potential issues, or implement targeted quality of service enhancements.

In the existing architecture, only the PCF and the User Equipment (UE) possess insights into the specifics of slice utilization. These entities maintain knowledge about which applications are employing which slices and the corresponding time frames of their usage. This centralized control allows the PCF to dictate policies and manage slice allocation based on real-time requirements and user demands.

The limitations in visibility across intermediate nodes highlight an area for potential improvement and innovation within 5G network architecture. Enhancing visibility for network elements beyond the PCF and UE could empower operators to gain a comprehensive understanding of slice utilization patterns, facilitating more informed decision-making, proactive network management, and the ability to optimize the overall performance of the 5G network. As the telecommunications industry progresses, addressing these visibility challenges becomes crucial for unlocking the full potential of dynamic network slicing capabilities.

The present disclosure is directed to using signaling transaction logs from 5G SA Core Platforms, such as the PCF and UPF. These insights can be derived to help mobile operators understand if the slicing technology is able to provide differentiated treatments for the respective cohorts of subscribers and their applications. By cross-referencing the PCF and UPF data, full visibility can be provided to ensure customer satisfaction. The data on these KPIs can allow the mobile operator to derive the subscriber's experience metrics based on their specific location to make real-time dynamic changes based on this visibility data. For example, the data from the KPI's for each of the network slices can be utilized to reallocate network resources from one slice to another slice. Furthermore, a machine learned model can also be implemented and dynamically tailored to the network resources to serve the subscribers.

Accordingly, a first aspect of the present disclosure is directed to a method for deriving 5G slicing insight at a telecommunications network. The method comprises receiving a first set of data from a UPF log, wherein the first set of data comprises data packet information. The method also comprises receiving a second set of data from a PCF log, wherein the PCF log identifies one or more network slices and wherein the second set of data comprises a signal exchange between a UE and the PCF. The method also comprises cross-mapping the first set of data and the second set of data using timestamp data to identify a data type for the one or more network slices and determining one or more KPIs for each of the one or more network slices using the data type. Based on the KPIs for each of the one or more network slices, the method comprises dynamically allocating resources across the one or more network slices.

A second aspect of the present disclosure is directed to a system for deriving 5G slicing insight at a telecommunications network, the system comprising one or more processors and one or more computer-readable media storing computer-usable instructions that, when executed by the one or more processors, cause the one or more processors to receive a first set of data from a UPF log, wherein the first set of data comprises data packet information. The system also comprises receiving a second set of data from a PCF log, wherein the PCF log identifies one or more network slices and wherein the second set of data comprises a signal exchange between a UE and the PCF. The system also comprises cross-mapping the first set of data and the second set of data using timestamp data to identify a data type for the one or more network slices and determining one or more KPIs for each of the one or more network slices using the data type. Based on the KPIs for each of the one or more network slices, the system comprises reallocating one or more network resources from a first slice to a second slice.

Another aspect of the present disclosure is directed to a system for deriving 5G slicing insight at a telecommunications network, the system comprising one or more processors and one or more computer-readable media storing computer-usable instructions that, when executed by the one or more processors, cause the one or more processors to receive a first set of data from a UPF log, wherein the first set of data comprises data packet information. The system also comprises receiving a second set of data from a PCF log, wherein the PCF log identifies one or more network slices and wherein the second set of data comprises a signal exchange between a UE and the PCF. The system also comprises cross-mapping the first set of data and the second set of data using timestamp data to identify a data type for the one or more network slices and determining one or more KPIs for each of the one or more network slices using the data type. Based on the KPIs for each of the one or more network slices, the system comprises reallocating network resources from a first slice of the one or more network slices to a second slice of the one or more network slices, wherein the first slice is determined to have one or more KPIs that exceed a threshold, and wherein the second slice is determined to have one or more KPIs that are below a threshold.

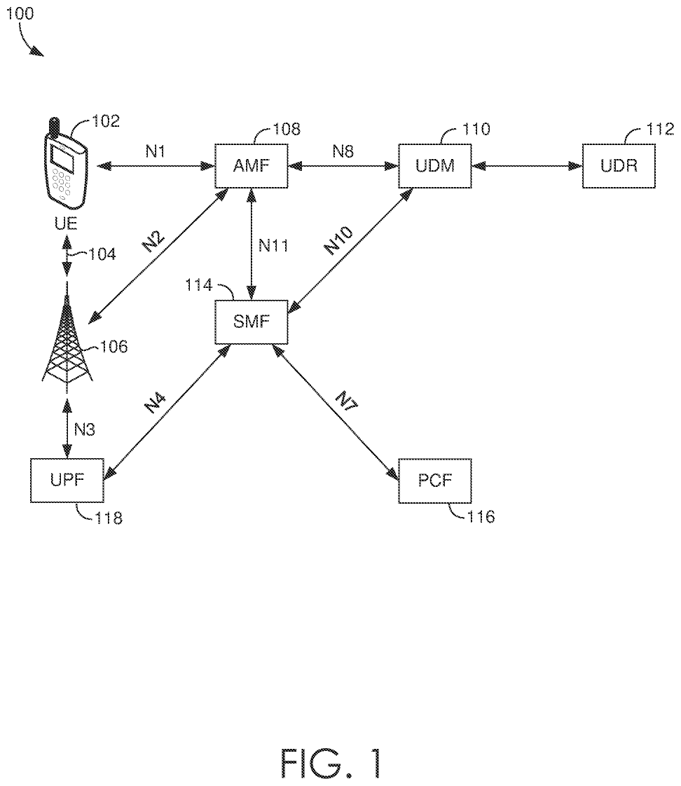

Turning to FIG. 1, a network environment suitable for use in implementing embodiments of the present disclosure is provided. Such a network environment is illustrated and designated generally as network environment 100. Network environment 100 is but one example of a suitable network environment and is not intended to suggest any limitation as to the scope of use or functionality of the disclosure. Neither should the network environment 100 be interpreted as having any dependency or requirement relating to any one or combination of components illustrated.

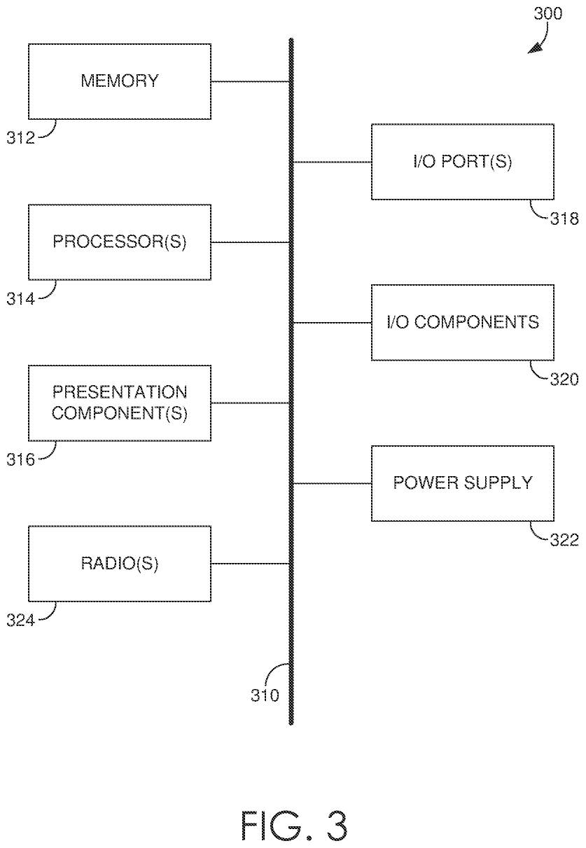

A network cell may comprise a base station to facilitate wireless communication between a communications device within the network cell, such as communications device 300 described with respect to FIG. 3, and a network. As shown in FIG. 1, communications device may be UE 102. In the network environment 100, UE 102 may communicate with other devices, such as mobile devices, servers, etc. The UE 102 may take on a variety of forms, such as a personal computer, a laptop computer, a tablet, a netbook, a mobile phone, a Smart phone, a personal digital assistant, or any other device capable of communicating with other devices. For example, the UE 102 may take on any form such as, for example, a mobile device or any other computing device capable of wirelessly communication with the other devices using a network. In embodiments, UE 102 comprises a wireless or mobile device with which a wireless telecommunication network(s) can be utilized for communication (e.g., voice and/or data communication). In this regard, the UE 102 can be any mobile computing device that communicates by way of, for example, a 5G network.

The UE 102 may utilize a network to communicate with other computing devices (e.g., mobile device(s), a server(s), a personal computer(s), etc.). In embodiments, the network is a telecommunications network, or a portion thereof. A telecommunications network might include an array of devices or components, some of which are not shown so as to not obscure more relevant aspects of the invention. Components such as terminals, links, and nodes (as well as other components) may provide connectivity in some embodiments. The network may include multiple networks. The network may be part of a telecommunications network that connects subscribers to their immediate service provider. In embodiments, network environment 100 is associated with a telecommunications provider that provides services to user devices, such as UE 102. For example, the network may provide voice services to user devices or corresponding users that are registered or subscribed to utilize the services provided by a telecommunications provider.

Accessing the telecommunications network is initiated at the base station 106 via communication link 104. The N1 and N2 interface are essential links from the UE 102 and base station 106 to the Access & Mobile Function (AMF) 108. The N1 interface is a transparent interface from the UE 102 to the AMF 108. It is used to transfer UE information to the AMF 108. The N2 interface connects the base station 106 to the AMF 108. N2 is important to connect the UE 102 to the network so that the UE 102 can access service. The AMF 108 handles connection and management mobility tasks. Essentially, the AMF 108 plays the role of the access point to the 5G core. The AMF 108 communicates with the Unified Data Management function (UDM) 110, the Session Management Function (SMF) 114, the Policy Control Function (PCF) 116 among others, via the N8, N11, and N15 interfaces, respectively. The N8 interface is the interface between the AMF 108 and the UDM 110. It is used during the registration process when the AMF 108 needs user data from the UDM 110 for UE authentication purposes. The N11 interface is the interface between the AMF 108 and the SMF 114. The SMF 114 interacts with the AMF 108 to establish, manage, and terminate sessions. Essentially, when the UE 102 requests a new session, the UE 102 and the base station 106 use the N1 and N2 interfaces to carry messages to the AMF 108. The AMF 108 takes care of connection and mobility management and then passes the request on to the SMF 114 via the N11 interface. The N15 interface is between the PCF 116 and the AMF 108 in the case of a non-roaming scenario, PCF 116 in the visited network and AMF 108 in the case of roaming scenario.

The UDM 110 is responsible for obtaining subscriber data that the SMF 114 accesses for managing user sessions on the network. Communications between the UDM 110 and the SMF 114, including requests from the SMF 114 to the UDM 110 and responses from the UDM 110 to the SMF 114, utilize the N10 interface. The UDM 110 can obtain subscriber data requested by the SMF 114 from a Unified Data Repository (UDR) 112 that stores the user information. While only one UDR is shown for simplicity in FIG. 1, it should be understood that the UDM 110 can be associated with more than one UDR.

The SMF 114 also communicates with the PCF 116 via the N7 interface. The communication via the N7 interface triggers session management policies towards the SMF 114. The SMF 114 further communicates with the UPF 118 via the N4 interface. The N4 interface is essential to provide necessary instructions to control and deliver the desired Quality of Service (QoS). The base station 106 communicates with the UPF 118 via the N3 interface.

Returning now to the N10 interface, once the AMF 108 triggers the SMF 114 that a new session is requested, the SMF 114 queries the UDM 110 via the N10 interface for user/subscriber data. When performing as intended, the UDM 110 replies to the SMF 114 with the requested subscriber data, the SMF 114 coordinates session information with the PCF 116 and the UPF 118 and communicates back the final session information to the AMF 108 and a session is initiated for the UE 102.

Focusing now on the UPF 118, it assumes a critical role in managing and facilitating the transmission of user data between the UE 102 and external networks. The UPF 118 is responsible for tasks such as routing, forwarding, and processing user plane data packets, ensuring adherence to communication protocols and standards. Its pivotal role extends to enforcing QoS policies; therefore prioritizing different types of data traffic for an optimized user experience. Additionally the UPF 118 supports traffic policing, shaping mechanisms, and plays a key role in the implementation of network slicing, allowing the creation of virtualized, isolated network segments tailored to specific services. The interaction between the UPF 118 and the SMF 114 is integral to the seamless operation of the 5G network. The SMF 114, responsible for managing session-related information, collaborates closely with the UPF 118 to orchestrate the establishment, modification, and termination of communication sessions. The UPF 118 aligns with the SMF 114 in enforcing QoS policies, ensuring that the user experience meets defined parameters. Moreover, in the context of network slicing, the UPF 118 collaborates with the SMF 114 to delineate and manage the characteristics of each network slice, catering to diverse service requirements. As the UPF 118 handles the user data or payload traffic, it works in conjunction with the SMF 114 to maintain visibility into session details, traffic descriptors, and route description parameters. However, it's noteworthy that the intermediate nodes within the core network and Radio Access Network (RAN) lack direct visibility into these aspects. Instead, the UPF 118, alongside the SMF 114, relies on the information stored in the Packet Data Network Gateway and the PCF 116 logs to understand which applications are utilizing specific slices and when these activities occur.

While the PCF 116 also provides valuable insights and control over the policies governing slice characteristics, it likewise does not offer complete visibility into the detailed activities and traffic within network environment 100. The PCF 116 primarily focuses on policy enforcement and decision making related to network slices. It stores policies defining the behavior of each slice, including parameters like latency, bandwidth, and priority. It can instruct the UPF 118 to apply these policies, ensuring that the network resources are allocated according to the specified rules. However, the PCF 116 does not have access to the data packet information necessary to gain a comprehensive understanding of the actual traffic, applications in use, and detailed session information to determine the latency and throughput needed by the user. Therefore, collaboration with other network functions is essential. By using timestamp data to cross-map data from the UPF 118 log and the PCF 116 log, there can be visibility into the payload traffic to see the relevant KPIs. Herein, the term “timestamp” refers to a piece of information indicating the specific time at which an event occurred or a particular piece of data was recorded and includes details such as the date, hour, minute, second, and sometimes fractions of a second.

For example, the base station 106 can receive a first set of data from the UPF 118 log, wherein the first set of data comprises data packet information. In aspects the data packet information comprises one or more of QoS metrics, session information, protocol information, and error logging. The base station 106 can also receive a second set of data from the PCF 116 log. The AMF 108 log can communicate with the PCF 116 log via the N15 interface, wherein the PCF 116 log identifies one or more network slices. The PCF 116 log and the UPF 118 log can comprise a type of log of a plurality of logs, wherein the plurality of logs comprise a record of transactions that are stored for one or more of monitoring, analyzing, or troubleshooting. The second set of data (from the PCF 116 log) comprises a signal exchange between the UE 102 and the PCF 116. In aspects, the signal exchange between the UE 102 and the PCF 116 comprises communication to establish and enforce policies for data services. In other aspects, the signal exchange between the UE 102 and the PCF 116 comprise a user equipment route selection policy (URSP), wherein the URSP determines a path that the data packet information should take.

Moving along, the base station can cross map the first set of data and the second set of data using timestamp data to identify a data type for each of the one or more network slices, wherein the timestamp data comprises a specific time when a data point occurred. In aspects, the data type comprises a common network slice between the first set of data and the second set of data. For example, if the system can identify the slice from the PCF 116 log and look at the timestamp, the system can pull the data from the UPF 118 log for the same timestamp and cross-map the data. By doing this, the system can see the signaling exchange between the PCF 116 and the UE 102. Next, the base station 106 can determine one or more KPIs for each of the one or more network slices using the data type, wherein the KPI threshold comprises one or more of latency and throughput. Based on the KPIs for each of the one or more network slices, the base station 106 can dynamically allocate resources across the one or more network slices. Alternatively, using the KPIs for each of the one or more network slices, the network can reallocate one or more network resources from a first slice to a second slice, wherein the first slice of the one or more network slices is different than the second slice of the one or more network slices. In alternative aspects, based on the one or more KPIs, the network can reallocate network resources from a first slice of the one or more network slices to a second slice of the one or more network slices. In aspects the first slice may be determined to have one or more KPIs that exceed a threshold, and the second slice may be determined to have one or more KPIs that are below a threshold. Alternatively, using the KPIs for each of the one or more network slices, the latency and throughput can be adjusted by one or more of increasing radio coverage strength or adjusting an angle of the base station 106 to improve customer experience.

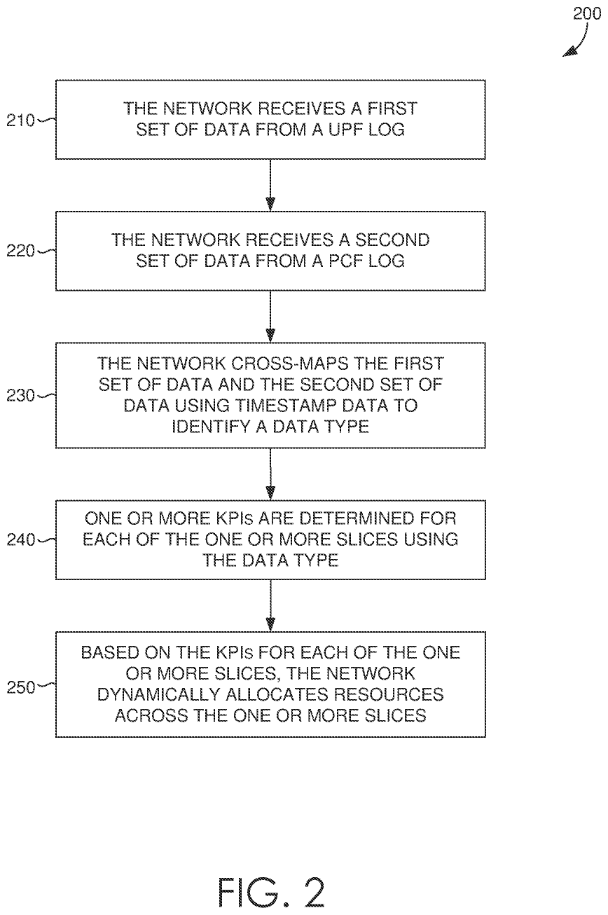

Turning to FIG. 2, a flow diagram 200 is provided illustrating a flow for deriving 5G slicing insight at a telecommunications network. Initially, at block 210, the network receives a first set of data from a user plane function (UPF) log, wherein the first set of data comprises data packet information. At block 220, the network receives a second set of data from a policy control function (PCF) log. The PCF log identifies one or more network slices. In aspects, the second set of data comprises a signal exchange between a user equipment (UE) and the PCF. At block 230, the network cross-maps the first set of data and the second set of data using timestamp data to identify a data type for each of the one or more network slices. At block 240, one or more key performance indicators (KPIs) are determined for each of the one or more network slices using the data type. Lastly, based on the KPIs for each of the one or more network slices, the network dynamically allocates resources across the one or more network slices at block 250.

Referring to FIG. 3, a block diagram of an exemplary computing device 300 suitable for use in implementations of the technology described herein is provided. In particular, the exemplary computer environment is shown and designated generally as computing device 300. Computing device 300 is but one example of a suitable computing environment and is not intended to suggest any limitation as to the scope of use or functionality of the invention. Neither should computing device 300 be interpreted as having any dependency or requirement relating to any one or combination of components illustrated. It should be noted that although some components in FIG. 3 are shown in the singular, they may be plural. For example, the computing device 300 might include multiple processors or multiple radios. In aspects, the computing device 300 may be a UE, or other user device, capable of two-way wireless communications with an access point. Some non-limiting examples of the computing device 300 include a cell phone, tablet, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

As shown in FIG. 3, computing device 300 includes a bus 310 that directly or indirectly couples various components together, including memory 312, processor(s) 314, presentation component(s) 316 (if applicable), radio(s) 324, input/output (I/O) port(s) 318, input/output (I/O) component(s) 320, and power supply(s) 322. Although the components of FIG. 3 are shown with lines for the sake of clarity, in reality, delineating various components is not so clear, and metaphorically, the lines would more accurately be grey and fuzzy. For example, one may consider a presentation component such as a display device to be one of I/O components 320. Also, processors, such as one or more processors 314, have memory. The present disclosure hereof recognizes that such is the nature of the art, and reiterates that FIG. 3 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of the present disclosure and refer to “computer” or “computing device.”

Memory 312 may take the form of memory components described herein. Thus, further elaboration will not be provided here, but it should be noted that memory 312 may include any type of tangible medium that is capable of storing information, such as a database. A database may be any collection of records, data, and/or information. In one embodiment, memory 312 may include a set of embodied computer-executable instructions that, when executed, facilitate various functions or elements disclosed herein. These embodied instructions will variously be referred to as “instructions” or an “application” for short.

Processor 314 may actually be multiple processors that receive instructions and process them accordingly. Presentation component 316 may include a display, a speaker, and/or other components that may present information (e.g., a display, a screen, a lamp (LED), a graphical user interface (GUI), and/or even lighted keyboards) through visual, auditory, and/or other tactile cues.

Radio 324 represents a radio that facilitates communication with a wireless telecommunications network. Illustrative wireless telecommunications technologies include CDMA, GPRS, TDMA, GSM, and the like. Radio 324 might additionally or alternatively facilitate other types of wireless communications including Wi-Fi, WiMAX, LTE, 3G, 4G, LTE, mMIMO/5G, NR, VOLTE, or other VoIP communications. As can be appreciated, in various embodiments, radio 324 can be configured to support multiple technologies and/or multiple radios can be utilized to support multiple technologies. A wireless telecommunications network might include an array of devices, which are not shown so as to not obscure more relevant aspects of the invention. Components such as a base station, a communications tower, or even access points (as well as other components) can provide wireless connectivity in some embodiments.

The input/output (I/O) ports 318 may take a variety of forms. Exemplary I/O ports may include a USB jack, a stereo jack, an infrared port, a firewire port, other proprietary communications ports, and the like. Input/output (I/O) components 320 may comprise keyboards, microphones, speakers, touchscreens, and/or any other item usable to directly or indirectly input data into the computing device 300.

Power supply 322 may include batteries, fuel cells, and/or any other component that may act as a power source to supply power to the computing device 300 or to other network components, including through one or more electrical connections or couplings. Power supply 322 may be configured to selectively supply power to different components independently and/or concurrently.

In other aspects, a machine learned model (i.e., artificial intelligence (AI)), trained using measurement sensors near highways, can be implemented to refine the greenhouse gas estimation. The AI system can use a range of techniques, encompassing supervised, unsupervised, and semi-supervised learning. In aspects, this incorporates a multitude of algorithms, such as decision trees, neural networks, clustering methods, and the like. In example aspects, the AI system consists of several input and output points. These points, or nodes, represent specific data features, undergoing various mathematical processes. Certain components (i.e., accelerometers and sensors) provide these data features and form the AI's decision basis. Prior to feeding data in the AI's training mechanisms, a preprocessing phase refined the input. This phase can involve tasks such as data cleansing, normalization, and scaling, to ensure data consistency and quality.

The AI system can also undergo feature extraction processes, which streamline and simplify the cast amounts of input data. This extraction determines the most critical data aspects and ensure an efficient machine learned model performance. Several feature extraction methodologies may be used, ranging from statistical methods to algorithm-based techniques. These methodologies aim to present the most relevant data in an efficient manner for the AI to process. The preprocessing phase may also tackle challenges such as missing data. Another facet or preprocessing involves identifying and managing outliers to ensure they do not skew the AI's decision-making process. Another component of preprocessing is feature scaling, which harmonizes data scales and ensures no single data type disproportionately influences the AI's operations. Feature selection is another crucial phase, focusing on pinpointing the most relevant data attributes for the AI's learning process. This phase can leverage various techniques to determine the data's most critical aspects.

Once preprocessing is complete, the AI undergoes training. During this phase, the system repeatedly processes the data, refining its internal parameters for the best performance. After training, the AI is deployed to handle real-world data (i.e., greenhouse gas estimation). The AI can translate this data into a format it understands, utilizing the patterns it recognized during its training phase.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and sub combinations are of utility and may be employed without reference to other features and subcombinations and are contemplated within the scope of the claims

In the preceding detailed description, reference is made to the accompanying drawings which form a part hereof wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A method for deriving 5G slicing insight at a telecommunications network, the method comprising:
receiving a first set of data from a user plane function (UPF) log, wherein the first set of data comprises data packet information;
receiving a second set of data from a policy control function (PCF) log, wherein the PCF log identifies one or more network slices, wherein the second set of data comprises a signal exchange between a user equipment (UE) and the PCF;
cross-mapping the first set of data and the second set of data using timestamp data to identify a data type for each of the one or more network slices;
determining one or more key performance indicators (KPIs) for each of the one or more network slices using the data type; and
based on the KPIs for each of the one or more network slices, dynamically allocating resources across the one or more network slices.

2. The method of claim 1, wherein the data packet information comprises one or more of Quality of Service (QoS) Metrics, session information, protocol information, and error logging.

3. The method of claim 1, wherein the signal exchange between the UE and the PCF comprises communication to establish and enforce policies for data services.

4. The method of claim 1, wherein the timestamp data comprises a specific time when a data point occurred.

5. The method of claim 1, wherein the data type comprises a common network slice between the first set of data and the second set of data.

6. The method of claim 1, wherein a first slice of the one or more network slices is different than a second slice of the one or more network slices.

7. A system for deriving 5G slicing insight at a telecommunications network, the system comprising:
one or more processors; and
one or more computer-readable media storing computer-usable instructions that, when executed by the one or more processors, cause the one or more processors to:
receive a first set of data from a user plane function (UPF) log, wherein the first set of data comprises a data packet information;
receive a second set of data from a policy control function (PCF) log, wherein the PCF log identifies one or more network slices and wherein the second set of data comprises a signal exchange between a user equipment (UE) and the PCF;
cross-map the first set of data and the second set of data using timestamp data to identify a data type for each of the one or more network slices;
determine one or more key performance indicators (KPIs) for each of the one or more network slices using the data type; and
using the KPIs for each of the one or more network slices, reallocating one or more network resources from a first slice to a second slice.

8. The system of claim 7, wherein the PCF log and the UPF log further comprise a type of log of a plurality of logs, wherein the plurality of logs comprise a record of transactions that are stored for one or more of monitoring, analyzing, or troubleshooting.

9. The system of claim 7, further comprising the signal exchange between the UE and the PCF comprises a user equipment route selection policy (URSP), wherein the URSP determines a path that the data packet information should take.

10. The system of claim 7, wherein the KPI comprises a KPI threshold comprising one or more of latency and throughput.

11. A system for deriving 5G slicing insight at a telecommunications network, the system comprising:
one or more processors; and
one or more computer-readable media storing computer-usable instructions that, when executed by the one or more processors, cause the one or more processors to:
receive a first set of data from a user plane function (UPF) log, wherein the first set of data comprises a data packet information;
receive a second set of data from a policy control function (PCF) log, wherein the PCF log identifies one or more network slices and wherein the second set of data comprises a signal exchange between a user equipment (UE) and the PCF;
cross-map the first set of data and the second set of data using timestamp data to identify a data type for each of the one or more network slices;
determine one or more key performance indicators (KPIs) for each of the one or more network slices using the data type; and
based on the one or more KPIs, reallocate network resources from a first slice of the one or more network slices to a second slice of the one or more network slices, wherein the second slice is determined to have one or more KPIs that are below a threshold.

12. The system of claim 11, wherein the KPI comprises a KPI threshold comprising one or more of latency and throughput.

13. The system of claim 12, further comprising adjusting the latency and throughput by one or more of increasing radio coverage strength or adjusting an angle of a cell tower.

14. The system of claim 11, wherein the data packet information comprises one or more of Quality of Service (QoS) Metrics, session information, protocol information, and error logging.

15. The system of claim 11, wherein the signal exchange between the UE and the PCF comprises communication to establish and enforce policies for data services.

16. The system of claim 11, wherein the timestamp data comprises a specific time when a data point occurred.

17. The system of claim 11, wherein the data type comprises a common network slice between the first set of data and the second set of data.

18. The system of claim 11, wherein the first slice of the one or more network slices is different than the second slice of the one or more network slices.

19. The system of claim 11, wherein the PCF log and the UPF log further comprise a type of log of a plurality of logs, wherein the plurality of logs comprise a record of transactions that are stored for one or more of monitoring, analyzing, or troubleshooting.

20. The system of claim 12, further comprising the signal exchange between the UE and the PCF comprises a user equipment route selection policy (URSP), wherein the URSP determines a path that the data packet information should take.
